(19) United States
(12) Patent Application Publication
(10) Pub. No.: US 2008/0304961 A1
(43) Pub. Date: Dec. 11, 2008

(54) Noise Reduced Variable Displacement Vane Pump

(76) Inventors: Gurvinder Bhogal, Brampton (CA); David Seto, North York (CA); Andy Bennett, Oakville (CA)

Correspondence Address: MAGNA INTERNATIONAL, INC., 337 MAGNA DRIVE, AURORA, ON, L4G-7K1, CA

(21) Appl. No.: 12/096,653

(22) PCT Filed: Dec. 11, 2006
(86) PCT No.: PCT/CA06/02019

§ 371 Date: Jun. 9, 2008

Related U.S. Application Data
(60) Provisional application No. 60/749,663, filed on Dec. 12, 2005.

(51) Int. Cl. F03B 11/02

(52) U.S. Cl. 415/208.1

(57) ABSTRACT

A novel and useful improvement to vane pumps, both variable displacement vane pumps and fixed displacement vane pumps, provides a supply of pressurized fluid to the region within the diameter of the pump rotor which would otherwise be a region of reduced pressure wherein air could be ingested by the pump. By reducing or preventing the ingestion of air, operating noise and damage to the pump can be reduced and wear in an engine or other system supplied from the pump can be reduced. The supply of pressurized working fluid also can be used to lubricate auxiliary components and/or accessories as well. Further, a portion of the supply of pressurized working fluid to this region can act to supercharge the pump, reducing the occurrence of cavitation at higher operating speeds.

### FIELD OF THE INVENTION

The present invention relates to vane pumps. More specifically, the present invention relates to vane pumps, and particularly variable displacement vane pumps (VDVPs), which generate less noise and/or are subject to reduced cavitation problems compared to many conventional designs.

### BACKGROUND OF THE INVENTION

Vane pumps are well known and are used in a wide variety of applications. Vane pumps have commonly been employed in automotive power steering and automatic transmission systems. More recently, vane pumps have been employed as automotive engine lubrication pumps. In particular, VDVPs have been used as automotive engine lubrication pumps as the ability to vary the displacement of the VDVP can result in increased overall efficiency of the engine.

However, while vane pumps, and in particular VDVPs, can provide several advantages over gear pumps or other pumps, they do suffer from some disadvantages. In particular, vane pumps can generate undesirable levels of noise when operating and/or can suffer from cavitation effects which, over time, damage components of the pumps.

### SUMMARY OF THE INVENTION

It is an object of the present invention to provide a novel vane pump which obviates or mitigates at least one disadvantage of the prior art.

According to a first aspect of the present invention, there is provided a vane pump for pressurizing a working fluid, comprising: a pump housing defining a rotor chamber and having an inlet port and an outlet port in fluid communication with the rotor chamber; a rotor rotatably mounted within the rotor chamber and having a plurality of vanes extending substantially radially from the rotor to form a series of pump chambers about the rotor, the rotor being mounted eccentrically with respect to the pump chamber such that the volume of the pump chambers increases adjacent the inlet port and decreases adjacent the outlet port as the rotor rotates to pressurize the working fluid; and a supply means to supply pressurized working fluid from the outlet port to a region inside the diameter of the rotor which would otherwise be a region of reduced pressure, the supply of pressurized working fluid reducing the ingestion of air by the pump when the pump is operating.

Preferably, the supply means comprises a groove extending from the outlet port to the region.

The present invention provides a novel and useful improvement to vane pumps, both variable displacement vane pumps and fixed displacement vane pumps, by providing a supply of pressurized fluid to the region within the diameter of the pump rotor which would otherwise be a region of reduced pressure wherein air could be ingested by the pump. By reducing or preventing the ingestion of air, operating noise and damage to the pump can be reduced. Further, a portion of the supply of pressurized working fluid to this region can act to supercharge the pump, reducing the occurrence of cavitation. Also, reducing or preventing the ingestion of air allows a pump, in accordance with the present invention, to produce higher output pressures of the working fluid during start-up with cold working fluid than a conventional pump could achieve, providing various benefits including reducing engine wear when the pump is a lubricating pump in a vehicle engine.

### BRIEF DESCRIPTION OF THE DRAWINGS

Preferred embodiments of the present invention will now be described, by way of example only, with reference to the attached Figures, wherein:

FIG. 1 shows a prior art variable displacement vane pump; and

FIG. 2 shows a variable displacement vane pump in accordance with the present invention.

### DETAILED DESCRIPTION OF THE INVENTION

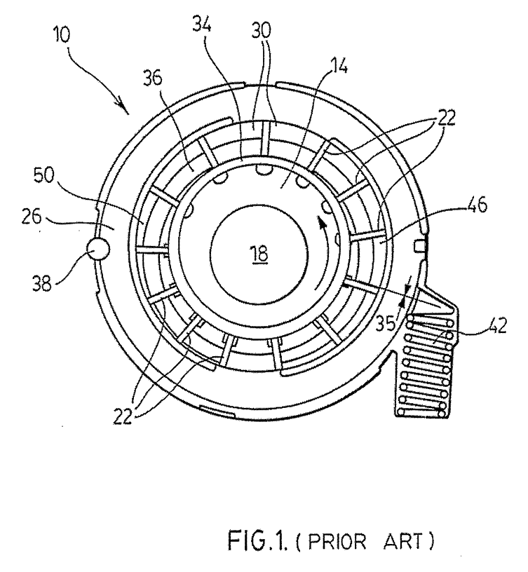

Before describing the present invention, a prior art variable displacement vane pump will be described, for clarity, with respect to FIG. 1. Prior art VDVP 10 includes a closed housing with a rotor 14 with a central bore 18 which engages and is rotated by a drive shaft (not shown). Rotor 14 includes a plurality of radially extending vanes 22 which engage the inner surface of a pump control ring 26 to form a series of pump chambers 30 about rotor 14.

Vanes 22 are radially moveable into and out of rotor 14 and, as the center of rotation of rotor 14 is located eccentrically to the center of pump control ring 26, a vane control ring 34 abuts the radially inner ends of vanes 22 to maintain the outer ends of vanes 22 in contact with the inner surface of pump control ring 26 while rotor 14 rotates in a pumping direction. A rotor sealing land 36 extends between the pump cover and the rotor to substantially radially seal rotor 14 within the closed housing to define an inner rotor core region and an outer pumping region. The seal substantially prevents working fluid enters the region of rotor 14 inside rotor sealing land 36. Further, the clearances 35 between vanes 22 and the slots in which they ride in rotor 14 are sufficiently small that they substantially seal vanes 22 to rotor 14 such that little working fluid enters the region of the rotor 14 inside rotor sealing land 36 while still allowing vanes 22 to move in and out of rotor 14 as needed.

Pump control ring 26 is moveable about a pivot 38 to alter the above-mentioned eccentricity of the center of rotation of rotor 14 and the center of pump control ring 26 to alter the volume of pump chambers 30 and thus the displacement of pump 10. Generally, a control mechanism is provided to move pump control ring 26 such that pump 10 operates at an equilibrium pressure.

In the illustrated embodiment, the control mechanism comprises a spring 42 which biases pump control ring 26 towards its maximum displacement position and another mechanism (not shown) generally responsive to a pressure in the hydraulic system supplied by pump 10 and/or the pressure at outlet port 50 of pump 10 and/or the pressure at the pump outlet (not shown) to counter the biasing force of spring 42.

As rotor 14 is rotated, working fluid is drawn from an inlet port 46, which is in communication with a pump inlet (not shown), into pump chambers 30 as the volume of pump chambers 30 increases. The working fluid is then expressed under pressure from pump chambers 30 into an outlet port 50, which is in communication with a pump outlet (not shown), as the volume of pump chambers 30 decreases.

While VDVPs such as pump 10 are widely employed, they do suffer from disadvantages, as mentioned above. In particular, as engine technologies have improved, resulting in a decrease in engine operating noise, the operating noise from conventional vane pumps has become more noticeable, especially at lower engine operating speeds such as at idle, resulting in this noise now generally being unacceptable. Also, vane pumps suffer from cavitation which increases operating noise, but which also damages pump components.

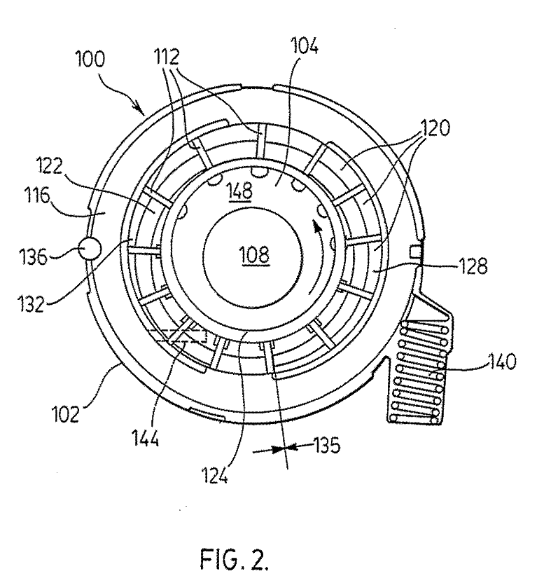

A vane pump in accordance with the present invention is indicated generally at 100 in FIG. 2. While pump 100 is a variable displacement vane pump, the present invention is not limited to VDVPs and can also be advantageously employed with fixed displacement vane pumps if desired.

In a similar manner to a prior art pump 10 discussed above, pump 100 comprises a housing 102 defining a closed pumping chamber. The housing has an arcuate inlet port 128 and an arcuate outlet port 132, as is conventional in the art. Both the inlet port 128 and the outlet port 132 communicate with the pumping chamber.

Rotor 104 is rotatably mounted within the pumping chamber and configured for driven rotation. Rotor 104 comprising a hub with a central bore 108 which engages and is rotated by a drive shaft (not shown). Rotor 104 includes an outer rim having a series of circumferentially spaced slots, each slidably receiving a radially extending vane 112. Preferably, the hub has an axial thickness which is less than an axial thickness of the outer rim of the rotor 104.

The outer end of each vane 112 engages the inner surface of a pump control ring 116 to form a successive series of pump chambers 120 about rotor 104.

A rotor sealing ring 122 engages each axial side of the outer rim of the rotor 104 between the pump cover and rotor 104 to substantially radially seal rotor 104 against the housing 102 and define an outer pumping region and an inner core region 148. The sealing ring 122 substantially prevents the working fluid, apart from a leakage amount, from moving from the pump chambers 120 in the outer pump region to the inner core region 148 of rotor 104 inside rotor sealing ring 122.

Also, the clearances 135 between vanes 112 and the slots in which they ride in rotor 104 are such that they substantially seal vanes 112 to rotor 104. In this manner, working fluid is substantially prevented from entering the core region of the rotor 104 inside rotor sealing land 122 while still allowing vanes 112 to move in and out of rotor 104 as needed.

A vane control ring 124 abuts the radially inner ends of each vane 112 urging the vanes into frictional engagement with the inner surface of the pump control ring 116. As the rotor 104 rotates in a pumping direction, the volume of each successive pump chamber 120 changes from a minimum volume, when a pump chamber 120 first enters fluid communication with an inlet port 128, to a maximum volume, when a pump chamber 120 is opposite its position of minimum volume, and then back to the minimum volume as rotor 104 continues to rotate.

As before, pump control ring 116 rotates about a pivot 136 within the pumping chamber to alter the eccentricity of the centers of pump control ring 116 and rotor 104 to vary the displacement of pump 100. A spring 140 biases pump control ring 116 to its position of maximum eccentricity, corresponding to the maximum displacement of pump 100, and a suitable control mechanism (not shown) moves pump control ring 116 against the biasing force of spring 140 to establish an equilibrium operating pressure.

The present inventors have determined that a significant amount of the operating noise of pump 100, especially at lower operating speeds, is the result of air which is ingested by pump 100. Specifically, the core region 148 of pump 100 within the outer rim of rotor 104 is an area of relatively low pressure into which air can be ingested from the drive shaft. This air mixes with working fluid to create a mixture of air and working fluid. This air-working fluid mixture increases pump noise in two ways.

The first way relates to the air-working fluid mixture being violently moved around and/or sloshing, within the region inside the rotor sealing land 122 and this movement creates noise. The second way involves the mixture of air and working fluid migrating to the low pressure region of pump 100 (i.e. adjacent inlet port 128), through rotor sealing land 122 and through the rotor slot clearances 135, due to a decreasing pressure gradient, existing in a region spanned by the circumferential length of the inlet port 128, in the direction of the low pressure region of pump 100 from the region inside rotor sealing land 122 of rotor 104. As the air and/or the mixture of air and working fluid enters pump chambers 120, the air moves with those chambers as rotor 104 rotates. The air and/or mixture of air and working fluid is compressed as the working fluid in pump chambers 120 is pressurized, finally resulting in the air and/or vapor bubbles imploding when the high pressures formed at outlet port 132 are encountered. These implosions result in significant pump operating noise and further, the force of these implosions can, over time, lead to damage of the components of pump 100.

Accordingly, the present inventors have determined that by supplying the inner core region 148 of rotor 104 with working fluid at a pressure above the pressure of the working fluid at inlet port 128 and/or above the ambient atmospheric pressure, the ingestion of air into the working fluid can be avoided, reducing the operating noise of pump 100 and mitigating or avoiding the damage to components of pump 100 which would otherwise occur from implosion of air and/or vapour bubbles in the working fluid.

To supply the necessary working fluid to the core region 148 inside rotor sealing land 122 at the inner diameter of rotor 104, the present inventors have provided a supply passageway or a groove 144 in the rear housing of pump 100. Groove 144 extends from a trailing end of outlet port 132 to core region 148 inside rotor sealing land 122. Preferably, groove 144 is angled relative to the radial direction. This orientation prevents flat contact between each of the vanes 112 and the edge of the passageway 144. When pump 100 is operating, pressurized working fluid at outlet port 132 communicates through groove 144 to pressurize core region 148.

Groove 144 is sized such that the volume of working fluid in region 148 is sufficient to substantially prevent the ingestion of air at the drive shaft of pump 100. As will be apparent to those of skill in the art, the size can be dependant on the pressure of the working fluid at outlet port 132 and the viscosity of the working fluid and/or other various factors and an appropriate size can be determined empirically or by analytic means.

As will be apparent to those of skill in the art, more than one groove 144 can be provided in pump 100. For example, one groove 144 can be formed in the rear housing of pump 100 while a second groove 144 can be formed in the front cover plate of pump 100, or two 144 grooves, somewhat spaced from one another, can be provided in the rear housing or front cover plate of pump 100. As will be apparent to those of skill in the art, the supply passageway of the present invention is not limited to a groove, or grooves, and any other suitable supply passageway, as will occur to those of skill in the art can be employed, such as a passage, slot, bore, etc.

As will be apparent to those of skill in the art, provided that an adequate amount of working fluid is provided to region 148 to substantially inhibit the ingestion of air, pump 100 will enjoy the above-mentioned reduction in operating noise and will avoid damage to pump components which might otherwise occur due to the implosion of bubbles of ingested air or vapour.

If working fluid is supplied to core region 148 in excess of that required to inhibit the ingestion of air, the excess working fluid can be used to lubricate other pump components or accessories via a passageway or orifice which directs the excess working fluid onto the component or accessory, albeit at the cost of some reduction in the efficiency of pump 100. For example, a groove (not shown) can be formed in rotor 104 to supply working fluid from region 148 to bore 108 to lubricate the drive shaft of pump 100.

An additional advantage can be obtained from the present invention as some portion of the working fluid supplied to region 148 will enter inlet port 128, through rotor sealing land 122 and clearances 135 and will serve to supercharge pump 100, which can assist in reducing cavitation in pump 100 at higher operating speeds. Further, by reducing or eliminating the presence of air in pump chambers 120, more working fluid is carried within pump chambers 120 and higher pressures can be produced by pump 100. This can be particularly significant during start ups when the working fluid is cold as such higher pressures can mitigate damage to engines or other systems supplied by pump 100.

As will now be apparent to those of skill in the art, the present invention provides a novel and useful improvement to vane pumps, both variable displacement vane pumps and fixed displacement vane pumps, by providing a supply of pressurized fluid to the region within the diameter of the pump rotor which would otherwise be a region of reduced pressure wherein air could be ingested by the pump. By reducing or preventing the ingestion of air, operating noise and damage to the pump can be reduced; the efficiency of the pump can be increased and the supply of working fluid to an engine or other system can be improved, reducing engine wear, etc. The supply of pressurized fluid can also be used to provide lubrication to auxiliary pump components and/or accessories and can act to supercharge the pump, reducing the occurrence of cavitation at higher operating speeds.

The above-described embodiments of the invention are intended to be examples of the present invention and alterations and modifications may be effected thereto, by those of skill in the art, without departing from the scope of the invention which is defined solely by the claims appended hereto.

What is claimed is:

1. A vane pump comprising:
a pump housing defining a rotor chamber and having an inlet port in fluid communication with the rotor chamber and an outlet port in fluid communication with the rotor chamber;
a rotor rotatably mounted within the rotor chamber and configured to be driven in a pumping direction, said rotor sealingly engaging said rotor chamber defining an inner core region and an outer pumping region, and said rotor having a plurality of vanes each biased to extend substantially radially from the rotor into the pumping region to form a series of pump chambers, the rotor being mounted eccentrically with respect to the rotor chamber such that as the rotor is driven in the pumping direction a volume of each successive pump chamber increases when in communication with the inlet port and decreases when in communication with the outlet port;
a vane control ring biasing each of said plurality of vanes; and
a passageway extending from the outlet port to the inner core region.

2. The vane pump of claim 1 wherein the outlet port has a trailing end relative to said pumping direction, and passageway is in fluid communication with the trailing end of outlet port.

3. The vane pump of claim 2 wherein the passageway is angled relative to each of the plurality of vanes as each of the plurality of vanes move past the passageway.

4. The vane pump of claim 3 wherein said passageway is sized to supply a volume of working fluid to the inner core region sufficient to substantially prevent ingestion of air into the housing.

5. The vane pump of claim 4 wherein vane pump further comprises a second passageway extending from the outlet port to the inner core region.

6. The vane pump of claim 1 further comprising a pump control ring pivotally mounted within the pump housing, radially outer ends of the vanes engaging an inner surface of the pump control ring and wherein the pump control ring is moveable to alter the eccentricity between the rotor and the pump control ring to alter the displacement of the vane pump.

7. The vane pump of claim 6 wherein the outlet port has a trailing end relative to said pumping direction, and passageway is in fluid communication with the trailing end of outlet port.

8. The vane pump of claim 7 wherein the passageway is angled relative to each of the plurality of vanes as each of the plurality of vanes move past the passageway.

9. The vane pump of claim 8 wherein said passageway is sized to supply a volume of working fluid to the inner core region sufficient to substantially prevent ingestion of air into the housing.

10. The vane pump of claim 9 wherein vane pump further comprises a second passageway extending from the outlet port to the inner core region.

11. The vane pump of claim 10 wherein the second passageway is on a side of the housing opposite said passageway.
